(19) United States
(12) Patent Application Publication
(10) Pub. No.: US 2024/0319496 A1
(43) Pub. Date: Sep. 26, 2024

(54) SELECTIVE SMART DIMMING SYSTEM

(71) Applicant: International Business Machines Corporation, Armonk, NY (US)

(72) Inventors: Brian Paul Gaucher, Brookfield, CT (US); Kevin W. Brew, Niskayuna, NY (US); Michael S. Gordon, Croton on Hudson, NY (US); Mattias Fitzpatrick, Mount Kisco, NY (US)

(21) Appl. No.: 18/189,334

(22) Filed: Mar. 24, 2023

(51) Int. Cl. G02B 27/00; G01S 17/86; G02B 27/02

(52) U.S. Cl. CPC G02B 27/0012; G01S 17/86; G02B 27/0093; G02B 27/024

(57) ABSTRACT

A method and related system selectively dims a proper subset of a plurality of tiles (DTPTs) that are a part of a contiguous dimmable transparent panel (DTP). Using a processor and in a real-time continuous feedback loop, the method comprises detecting, using a light source detector with an outward facing sensor, a location of an illumination source within a volume adjacent to an outside surface of the DTP. The method further comprises determining, using a head/eye detector with an inward facing sensor, a viewer's gaze direction within a volume adjacent to an inside surface of the DTP. The method further comprises determining a panel intersection point for a light ray extending from the illumination source location along the viewer's gaze direction. Finally, the method comprises selectively dimming the proper subset of DTPTs proximate the panel intersection point.

### BACKGROUND

A system and method are described below for operating a transparent medium having selective smart dimming.

### SUMMARY

Disclosed herein is a method that selectively dims a proper subset of a plurality of tiles (DTPTs) that are a part of a contiguous dimmable transparent panel (DTP). Using a processor and in a real-time continuous feedback loop, the method comprises detecting, using a light source detector with an outward facing sensor, a location of an illumination source within a volume adjacent to an outside surface of the DTP. The method further comprises determining, using a head/eye detector with an inward facing sensor, a viewer's gaze direction within a volume adjacent to an inside surface of the DTP. The method further comprises determining a panel intersection point for a light ray extending from the illumination source location along the viewer's gaze direction. Finally, the method comprises selectively dimming the proper subset of DTPTs proximate the panel intersection point.

A system is also disclosed herein for selective dimming of a proper subset of a plurality of tiles (DTPTs) that are a part of a contiguous dimmable transparent panel (DTP). The system comprises a memory and a processor. The processor is configured to, in a real-time continuous feedback loop, detect, using a light source detector with an outward facing sensor, a location of an illumination source within a volume adjacent to an outside surface of the DTP. The processor is further configured to determine, using a head/eye detector with an inward facing sensor, a viewer's gaze direction within a volume adjacent to an inside surface of the DTP. The processor is further configured to determine a panel intersection point for a light ray extending from the illumination source location along the viewer's gaze direction. Finally, the processor is further configured to selectively dim the proper subset of DTPTs proximate the panel intersection.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a general computing device and environment.

FIG. 2A is a pictorial block diagram that illustrates an example selective dimmable transparent panel system and its basic components, according to some embodiments.

FIG. 2B is a pictorial block diagram that illustrates a light source shining through a dimmable transparent panel, according to some embodiments.

FIG. 2C is a pictorial diagram that illustrates the spatial relationship of a dimmable transparent panel, viewers, light sources, objects, and sensors in the form of cameras, according to some embodiments.

FIG. 3 is a block diagram illustrating the major components of the dimmable transparent panel system, according to some embodiments.

FIG. 4 is a flowchart illustrating an example process for operating the dimmable transparent panel system, according to some embodiments.

### DETAILED DESCRIPTION

The following general acronyms may be used below:

TABLE 1
General Acronyms

| | |
|---|---|
| CD-ROM | compact disc ROM |
| CPP | computer program product |
| DVD | digital versatile disk |
| EPROM | erasable programmable read-only memory |
| EUD | end-user device |
| IoT | Internet of Things |
| LAN | local-area network |
| NFC | near field communication |
| RAM | random access memory |
| ROM | read-only memory |
| SAN | storage area network |
| SD | secure digital |
| SDN | software-defined networking |
| SRAM | static random-access memory |
| UI | user interface |
| USB | universal serial bus |
| VCE | virtual computing environment |
| WAN | wide-area network |

### Data Processing System in General

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

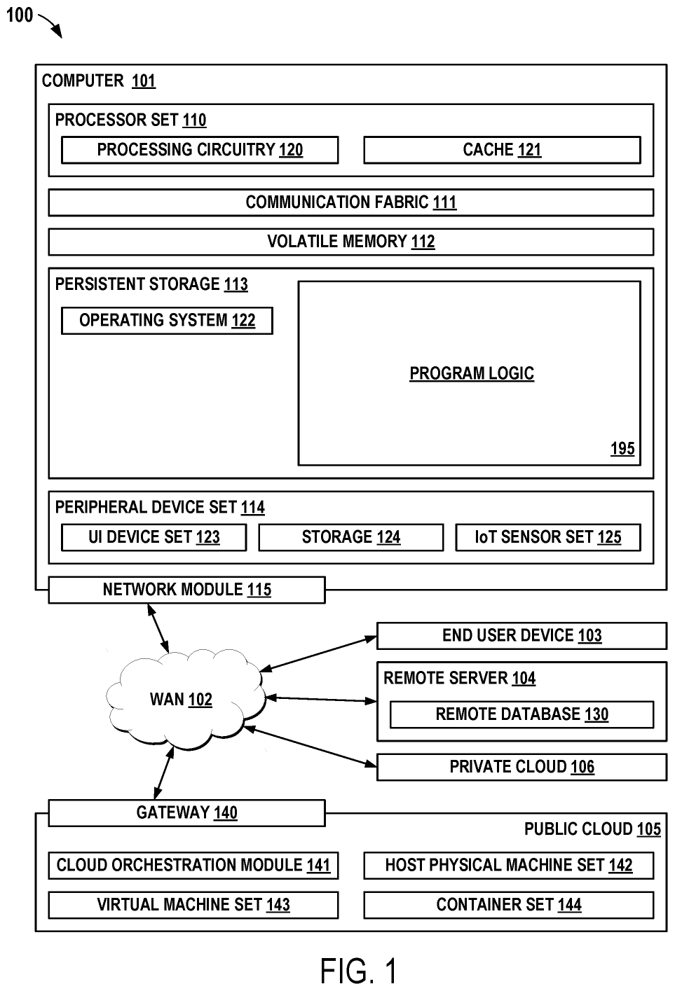

FIG. 1 is a block diagram of a general computing device and environment. Computing environment 100 contains an example of an environment for the execution of at least some of the computer code involved in performing the inventive methods disclosed herein, including program logic 195 that may be implemented in various combinations of hardware and/or software described below. In addition to the program logic 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program logic 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the program logic 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the program logic 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention are presented for purposes of illustration, but are not intended to be exhaustive or limited to the embodiments disclosed. Many modifications and variations will be apparent to those of ordinary skill in the art without departing from the scope and spirit of the described embodiments. The terminology used herein has been chosen to best explain the principles of the embodiments, the practical application or technical improvement over technologies found in the marketplace, or to enable others of ordinary skill in the art to understand the embodiments disclosed herein.

Certain reference numbers or characters may be represented as being pluralities (e.g., 100.1, 100.2, etc.). In such instances, reference to a single reference number (e.g., 100) may represent the plurality of entities, or may represent an example of the set, depending on the context. This similarly applies to reference numbers or characters that use subscripts.

### Selective Smart Dimming System

The following application-specific acronyms may be used below:

TABLE 2
Application-Specific Acronym

| | |
|---|---|
| DTP | dimmable transparent panel |
| DTPG | dimmable transparent panel group |
| DTPT | dimmable transparent panel tile |
| FoV | field of view |
| LCD | liquid crystal display |

### Selective Smart Dimming

The human eye is very adaptable to different levels of lighting, and can adjust to light level changes relatively quickly. There are limitations to this adaptability, however. One limitation is that the overall light intensity in a particular situation may be high enough to cause discomfort and impair a viewer's ability to accurately view a scene. In these situations, a user may squint and/or use their hands to partially shield a part of the light source. Impinging light (e.g., glare) can harm visibility and create unsafe situations.

The viewer may be protected from such impinging light by taking advantage of light filters that block a portion of incoming light for a transparent entity, such as a window or a lens. This light filtering may be used in settings which are routinely illuminated with high levels of light, such as a with a window in a building that faces the sun at times, or with an automobile window that may be exposed to the sun at times. The viewer may also wear sunglasses in which the filtering is applied to wearable lenses.

This type of filtering, when of a permanent or unchangeable nature, may present disadvantages when the lighting is dimmed. Sunglasses may, of course, be removed, but fixed window tinting may not be practically removed when the lighting is dimmed. And when light fluctuations are frequent, even the removal and replacement of sunglasses becomes impractical.

In these situations, adaptable light filtering or polarizations may be applied that senses a light level and increases the light filtering in response to, and in some instances, in proportion to, an increased level of light sensed by the window or glasses lens. In some instances, the sensing of the light level is performed by material on the transparent element itself. An example of this is adaptable sunglasses, such as the transition lenses introduced in the 1990s, that darken when the wearer steps out into the sunlight, but lighten when the wearer goes inside.

Electrochromic transitions have been known since the early 1970s that are based on tungsten trioxide using electrical fields. More recently, these materials have been implemented with replacing a transparent conductive electrode with reflective surfaces (e.g., metals Ag, Au, Al); these reflective devices have been implemented in car rear-view mirrors and displays. As described herein the term “transparent element” may also refer to a reflective element for the sake of conciseness—and most reflective elements have a transparent layer in front of the mirrored surface that may constitute the “transparent element”.

The light sensor may be separate from the transparent element itself, and the dimming here is controlled by an element separate from the transparent element material. For example, windows on some modern aircraft utilize liquid crystal display (LCD) technology where a level of dimming may be controlled by a window seat passenger and/or a system of the aircraft.

One issue, however, is that often there are acute bright light sources that do not require a full panel of auto-dimming-whole/entire dimming of a window or other large transparent entity, even when adjustable/controllable at a large scale, may also create difficulties to visibility, especially at night. For example, if a viewer is driving their car at night, and another vehicle having their bright lights (high beams) on approaches in the opposite direction, a dimming of the entire front window may help prevent the viewer from being blinded by the bright lights. However, this may also harm the driver's visibility of their surroundings. For example, this may darken a portion of the front window in which an object, such as a deer or a pothole, is present, thus preventing the viewer from properly seeing potential hazards. In another example, a laser may be pointed at an airplane cockpit. This may cause temporary night vision blindness for the pilot and/or copilot.

Various embodiments disclosed herein address such situations by selectively dimming only portions of a transparent element that may cause problems for viewers, while leaving other portions undimmed so that the viewer is not hindered unnecessarily. In order to achieve this, transparent elements that make up the transparent entity, such as a vehicle window, may be individually dimmable so that only transparent elements necessary to avoid blinding the viewer are dimmed.

In order to achieve this, however, the location of the light source and its intensity, along with the location of the viewer's eyes or the direction of the viewer's gaze, relative to the transparent elements, may be determined in real-time so that only the necessary transparent elements are dimmed to protect the viewer's eyes. While it is preferable to evaluate a direction of the viewer's gaze as opposed to the location of the viewer's eyes, certain constraints may limit the ability to determine a gaze direction and/or to process gaze direction in a timely manner. For example, the viewer may be wearing sunglasses, which may make a determination of the viewer's gaze difficult. In such instances, the location of the viewer's eyes may be used, and, in some embodiments, a gaze direction from the viewer's eyes to the light source may be used. In other embodiments in which eye location is used, it may be possible to determine an orientation of the viewer's head, and a presumption may be made that the viewer's gaze is straight ahead, relative to head orientation. As used herein, the term “gaze direction” is defined not only as an actual gaze direction of the viewer (which may be mathematically defined as a vector or ray having a starting position at an eye location of the viewer), but also as a proxy (for the sake of simplicity) for eye location or presumed gaze direction (either to the light source or straight ahead relative to the head orientation), where the actual gaze direction cannot be determined or timely used. Thus, when determinable, the actual gaze direction may be an actual/measured/sensed/determined gaze direction, and when the actual gaze direction is not determinable, due to sensor, timing, or other constraints, the gaze direction may be an implied gaze direction (either in a direction from the eye to the light source (i.e., the light source vector and the eye gaze direction are co-linear), or straight ahead according to a head orientation). The phrase “determining an eye gaze direction” may include determining any of these.

For purposes of this disclosure, real-time may be defined as 1.0 sec. or less, but may also encompass situations benefitting from substantially slower (e.g., conference room windows) or faster (e.g., highway speed driving (when adequate processing power is available)) response times. The operations of light sensing, eye sensing, and dimming of portions of the panel may be performed in a continuous feedback loop to accommodate a moving light source (for example, an oncoming car's lights) and/or moving vehicle (for example, a streetlight).

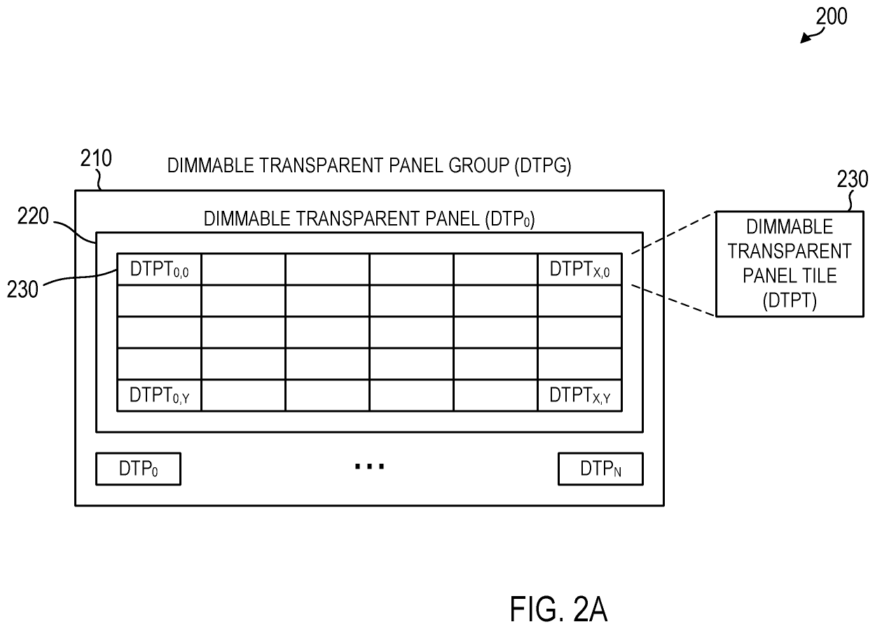

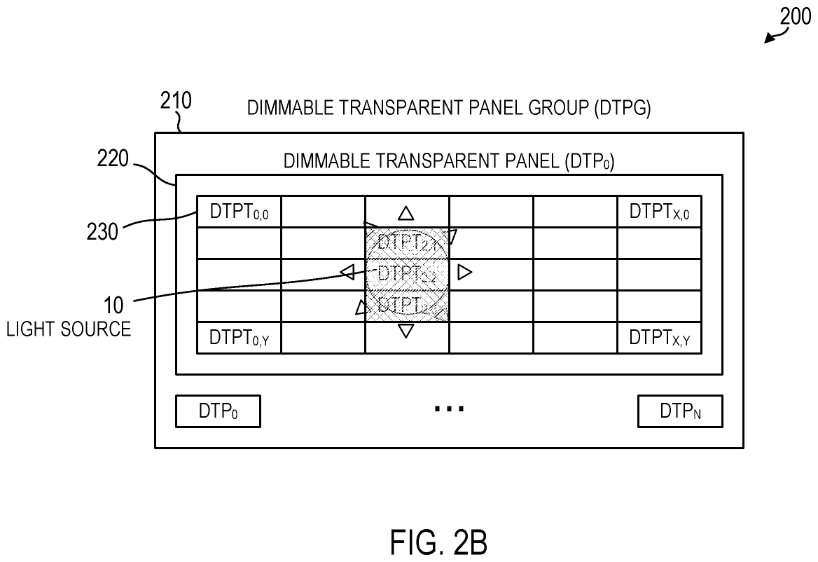

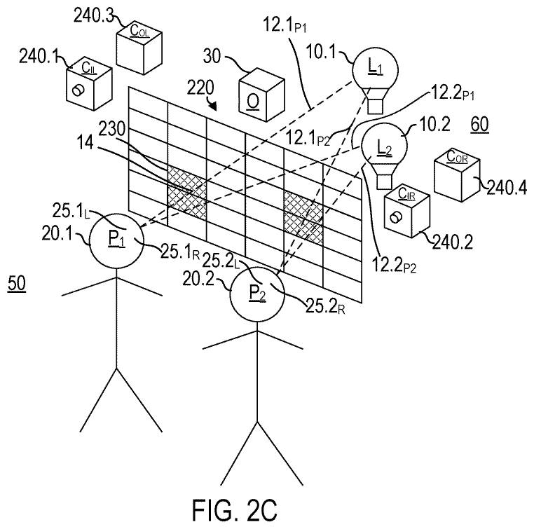

The feedback loop may be tight, e.g., on the order of fractions of a second, for situations in which position of the light source 10 or the eye gaze 25 (see FIG. 2C) are expected to change rapidly, such as might be encountered during nighttime driving. Alternately, the feedback loop might be looser, e.g., on the order of several seconds or longer, for situations in which positions of the light source 10 or the gaze direction of the eyes 25 are expected to change slowly, such as might be encountered with window glass in a conference room where the sun's position relative to the glass changes very slowly. In some embodiments, the system may be used on panels in the aircraft industry to protect a pilot's (or passenger's) eyes from lasers, or from changing illumination conditions (like turning towards or away from the sun). In such applications, the response time is fairly fast in order to prevent possible temporary or permanent vision impairment from the laser.

In some embodiments, there may be multiple viewers. In such instances, different transparent elements or sets of transparent elements of the transparent entity are dimmed depending on a gaze direction. In some embodiments, the orientation of the viewer's eyes may be taken into consideration as well. For example, if a viewer is not looking at the light source, it may not be necessary to dim the relevant transparent elements that would be dimmed otherwise, or, it may not be necessary to dim them as much. In some embodiments, individual viewers 20 may specify a level of dimming or indicate a tuning of the dimming level. Such an input for control may be made by voice command or the viewer entering such information via a dimming control application on their own mobile device.

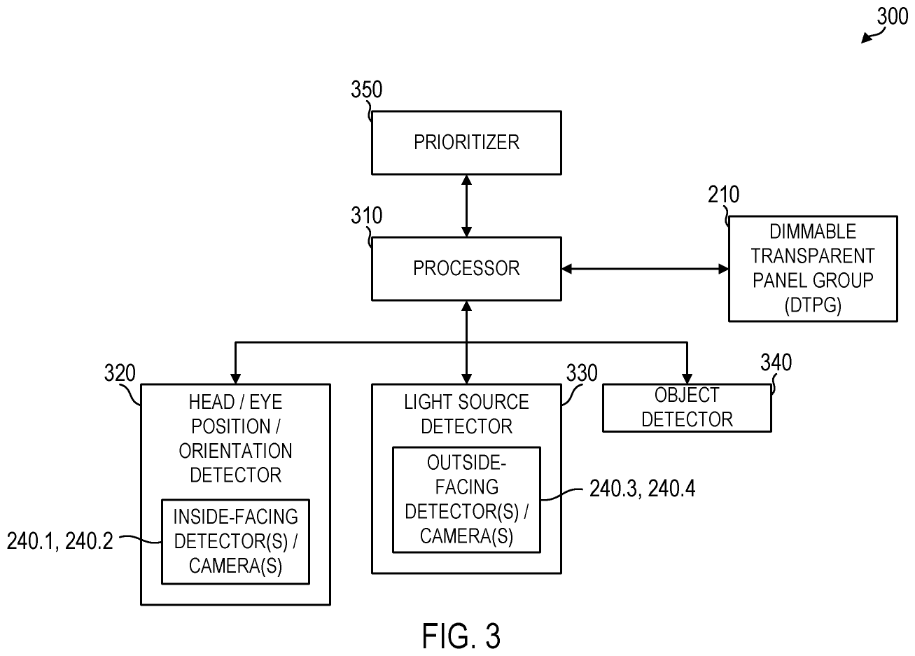

FIG. 2A is a pictorial block diagram that illustrates an example selective dimmable transparent panel system 200. FIG. 2B is a pictorial block diagram that illustrates a light source shining through a dimmable transparent panel. FIG. 2C is a pictorial diagram that illustrates the spatial relationship of a dimmable transparent panel, viewers, light sources, objects, and sensors in the form of cameras. FIG. 3 is a block diagram illustrating the major components of the dimmable transparent panel system. FIG. 3 will be discussed in parallel with FIGS. 2A-2C.

As shown in FIG. 2A, a dimmable transparent panel group (DTPG) 210 may comprise a plurality of contiguous dimmable transparent panels (DTPs) 220, and the DTPs 220 may comprise a plurality of individually controllable dimmable transparent panel tiles (DTPTs) 230. The DTP 220 is a generally cohesive and coherent transparent panel element that is essentially “one-piece”, such as a car windshield, whereas the DTPG 210 may be a group or set of DTPs 220 that may be in separate pieces, but are controlled together, such as the set of car windows including the windshield, side windows, rear window, sunroof, etc.

FIG. 3 shows a processor 310 that interfaces via a bus or network to the DTPG 210. Although a single controller processor 310 is shown, there may be a hierarchy of processors at different levels. For example, for the single controller processor 310, each DTP 220 may have an address associated with it, and within each DTP 220, each DTPT 230 may have a further address associated with it. Thus, in some embodiments, direct control of each DTPT 230 may be done from a common processor 310.

Furthermore, the components illustrated in FIG. 3 are shown using a common processor 310. However, each of the components may utilize their own processor, use any combination of shared processors, etc. The processor(s) 310 may be implemented, for example, within the computer environment 100 described above and may comprise a computer 101 and its associated components, as described above.

In some embodiments, each DTP 220 may have its own processor (not shown). In this instance, the highest level controller processor 310 communicates instructions for dimming to a lower-level processor associated with each DTP 220, and the lower-level processors control the darkening/dimming of the individual DTPTs 230. The terms darkening and dimming, as used herein, are defined as a partial or whole blocking of light rays travelling through a transparent medium or panel.

The DTPT 230 is the smallest controllable dimmable element within the selective smart dimmable panel system 200. The DTPT 230 may be any arbitrary size, but may be as small as an individual pixel using a pixel size according to a smallest currently available technology (i.e., in the μm range)—however, a cost vs. benefit analysis would likely favor a substantially larger size. In many instances (e.g., vehicle windows), a sub-inch area (e.g., 1-6 mm²) will prove adequate. The DTPT 230 area size may also be dependent upon the application of its use. For example, a large and distant window in a building might operate effectively with relatively large DTPTs 230, whereas an airplane cockpit window might require significantly smaller DTPTs 230. Although the DTPTs 230 shown in FIG. 2A are illustrated as rectangles that tile the DTP 220, the DTPTs may be any shape. For example, the DTPTs 230 may be regular hexagons or triangles that completely tile DTP 220. Alternately, the DTPTs 230 may be irregular shapes that include straight and/or curved edges, and they do not all have to take on the same shape for the entire DTP 220. In some embodiments, the DTPTs 230 may leave gaps in the DTP 220 that are not dimmable. For example, in a vehicle, it may be determined that only the driver side of the windshield needs DTPTs 230 in order to reduce cost. The DTPTs 230 may be flat or contoured in three dimensions, the former being usable for both a flat and contoured DTP 220. The actual size of the DTPT 230 is somewhat arbitrary, and may be application dependent. For example, a DTPT 230 used in a car window may have a size on the order of one to ten square inches, whereas a DTPT 230 for a window in a high rise might have a size on the order of one hundred to five hundred square inches.

The DTPTs 230 may comprise tiles of auto-dimming glass(es), for example, electrochromic devices or devices using e.g., a matrix of small micro-shutters where a proper subset of DTPTs 230 making up a DTP 220 can be engaged to affect light transmission by restricting an amount of light transmitted through the DTPTs 230. The DTPTs 230 may have an address associated with them that uniquely defines them within a given DTP 220. This address is shown, by way of example only, as rectangular coordinate offsets in FIG. 2A, ranging from DTPT_{0,0} to DTPT_{x, y}, however, any addressing scheme may be utilized. Each of the DTPTs 230 may have an entry in a database that contains relevant information about that DTPT 230. Furthermore, the address of the DTPT 230 may be used by a controller to send an amount of dimming to the DTPT 230. For example, a value may be sent ranging from 0-255, where 0 represents completely dark and 255 represents completely transparent, with a range of dimming in between. This is clearly just an example, and a courser or finer gradation in the range may be applied as practical. A dimming amount of zero, as used herein, may be synonymous with a binary decision not to dim, and any other dimming amount may be synonymous with a binary decision to dim. In embodiments in which only a binary indication of dimming is provided, the no dimming condition may correspond with a value of zero, and dimming may correspond with a value of, e.g., 255 (i.e., complete dimming), although it may also be possible, through various system settings, to establish a maximum amount of dimming for the system to use (e.g., never dim more than 50%).

The DTP 220 is a transparent element that is made up of the DTPTs 230. It may be flat or contoured in three dimensions. Some examples of DTPs 220 include an automobile window, an aircraft or other vehicle windows, a building window, a virtual reality headset window, and the like. Multiple DTPs 220 may make up a DTPG 210. By way of illustrative example, a DTPG 210 on a vehicle may comprise a front window, front-seat side windows, rear seat side windows, and a rear window, with each of the respective DTPs 220 constituting a respective window. Similarly, in a building, the DTPG 210 may comprise a plurality of windows as DTPs 220 for north-view, cast-view, west-view, and south-view windows. Although FIG. 2A illustrates three levels of a hierarchy of elements, the number of hierarchical elements or groupings is not limited, and may take on any number suitable for a particular application. For example, in a building, a north wall may have several windows that are grouped together. Given their common planar relationship to the sun, these may all be treated as a north DTPG 210. However, on the cast wall, these have a different positional relationship to the sun and may be treated differently, thus forming another hierarchical level.

FIG. 2B is a pictorial block diagram illustrating an implementation of a DTP 220, which may be one DTP 220 of a DTPG 210. In this example illustration, a viewer sits behind the DTP 220 and the sun, as a light source 10, is directly in front of the viewer. The DTPTs 230 DTPT2.1, DTPT2.2, and DTPT2.3 are dimmed, while the remaining DTPTs 230 of the DTP 220 are left transparent. In this way, the viewer has maximum visibility through the DTPTs 230 that are not dimmed, without being blinded by the sun. The DTP 220 may, in some embodiments, be implemented as a film that may be applied over a transparent panel. In these embodiments, the dimming elements and addressable wiring of the DTPTs 230 may be embedded in the film, and an electronic interface may be provided to connect to controlling circuitry located in a location that does not block a view through the transparent panel. Such a film may be provided as an aftermarket product.

FIG. 2C is a pictorial diagram illustrating the spatial relationship between a primary viewer P20.1 (P₁), and a secondary viewer P20.2 (P₂) who each have respective right and left eyes P25.1_{R}, P25.1_{L}, P25.2_{R}, P25.2_{L}, the DTP 220 and its constituent DTPTs 230, the light sources 10.1 (L₁), 10.2 (L₂), an object 30 (O), inward-facing right and left cameras 240.1 (C_{IL}), 240.2 (C_{IR}), and outward-facing cameras 240.3 (C_{OL}), 240.4 (C_{OR}). The term “camera”, as used herein, is a proxy for any type of sensor that is capable of receiving and processing image data of its surroundings. Such sensors for which the term “camera” serves as a proxy for herein include lasers, light detection and ranging (LIDAR) systems, sonic distance and velocity measuring mechanisms, and the like. The sensors may also comprise circuitry and/or algorithms that may determine if undesirable reflections exist that may impact the user and or image processing and deal with such reflections accordingly.

Additionally, as shown, two inward-facing eye-detecting sensors, such as cameras 240.1 (C_{IL}), 240.2 (C_{IR}) for determining the gaze direction of eyes 25, and viewer head orientations are provided. Furthermore, two outward-facing illumination-source/object sensors, such as cameras 240.3 (C_{OL}), 240.4 (C_{OR}) are provided for detecting light sources 10 and objects 30. However, it is possible to use additional cameras 240 for greater speed and accuracy, or to capture multiple entities (e.g., the eyes of passengers in a rear seat, complex environmental light sources and objects), if desired.

The system 300, in a general mode of operation: a) determines light direction, which is a line in space representing a light ray 12 emanating from a light source L 10 and going to an eye 25 of a viewer 20; b) determines a point where that light ray 12 intersects a surface of the DTP 220; and c) dims a subset of the DTPTs 230 that are proximate the intersection point. As used herein, the term “proximate the intersection point” means DTPTs 230 in the subset that are to be dimmed such that the harmful effects of the light source L 10 are reduced or minimized prior to reaching the viewer's eye 25.

As illustrated in more detail in FIG. 2C, a plurality of light rays 12 are determined by the light source detector 330 using detectors 240.3, 240.4, such as the outward-facing cameras. The light rays are further determined by their endpoints, which constitute the eyes 25 of the viewers 20, as determined by the head/eye position/orientation detector 320 (also referred to herein as a head/eye detector) using detectors 240.1, 240.2, such as the inward facing cameras. An intersection point on the DTP 220 may be determined, and the particular DTPTs 230 at which the light ray intersects the DTP 220 may be darkened using a controller of the particular DTPTs 230, the DTP 220, and/or the DTPG 210.

From the first light source L1 10.1, two rays are determined: a first ray 12.1p1 from the first light source L1 10.1 to the primary viewer P1 20.1, and a second ray 12.1p2 from the first light source L1 10.1 to the secondary viewer P2 20.2. From the second light source L2 10.2, two rays are determined: a first ray 12.2p1 from the second light source L2 10.2 to the primary viewer P1 20.1, and a second ray 12.2p2 from the second light source L2 10.2 to the secondary viewer P2 20.2. In some embodiments, a further refinement may be made that is not illustrated in FIG. 2C: two rays may be determined from a given light source for a given person P1 20.1—the first to the person's 20 right eye, and the second from the person's 20 left eye. As a general rule, such a refinement is not necessary, since the person's two eyes may be represented as a single point, e.g., at one of the eyes or in between both eyes. Such a representation would likely result in the same DTPTs 230 being darkened in response to a particular light source. However, delineating between the right and left eye may be accomplished if the DTPTs 230 are relatively small enough.

The outward-facing cameras 240.3, 240.2, may determine an intensity of the light source 10 and dim the DTPTs 230 in a manner that depends on the intensity of the light source 10. For example, the DTPTs 230 may be dimmed to allow 70% of the light in if the light source 10 is not very bright, whereas the DTPTs 230 may be dimmed to allow 0% of the light in if the light source 10 is very bright. Similarly, the response time of the dimming may be determined based on the intensity of the light source 10. For example, the DTPT 230 may be dimmed slowly and undimmed slowly if the light source 10 is not very bright (e.g., over the course of a few seconds), whereas the DTPT 230 may be dimmed as quickly as possible if the light source 10 is very bright (e.g., on the order of 0.01 s for sudden bright lights, such as a car with its high beams on suddenly appearing over a hill).

In some embodiments, the dimming or amount of dimming for the DTPT may be context sensitive, e.g., based on a detected (e.g., ambient light) or determined (e.g., time is past sunset) context. For example, a full moon may trigger no dimming at all during the day when the sun is out, but may trigger some or full dimming at night. The outside cameras 240.3, 240.4 may be used to obtain an ambient level of lighting in order to determine a light context for dimming.

The inward-facing right and left cameras C_{IL}, C_{IR} 240.1, 240.2 may use standard recognition techniques to determine how many viewers 20 are located in the region to be protected 50, where the DTP 220 presents a division between the region to be protected 50 and a light source region 60. A location and, optionally in some embodiments, orientation/direction, of the eyes 25 of the viewers 20 may be determined by these cameras 240. In some embodiments in which an eye gaze direction is sensed, it may be possible to only darken the necessary DTPTs 230 in which the viewer's 20 gaze is directed. In any case, in some embodiments, a viewer's 20 (estimated) field of view (FoV) may be used in considering a direction of the viewer's 20 gaze, and which DTPTs 230 to dim and an amount of dimming for each may take the FoV into consideration. For example, a viewer's 20 FoV may span, e.g., 45°, so a light ray entering the viewer's eye 25 at anything less than this FoV may determine candidate DTPTs 230 for dimming. However, a viewer's eyes 25 are not as sensitive towards the edges of their FoV, and in these circumstances, the dimming may be more pronounced when the light ray hitting the eye 25 is at 0° than when it is hitting the eye 25 at 45°. Put differently, the amount of dimming may vary based on an FoV angle from a direction of the viewer's gaze. In some embodiments, the gaze direction may be updated in real-time so that the dimmed DTPTs 230 may follow the changing gaze direction. In some embodiments, a changing gaze direction may be inferred, based on, e.g., immediately preceding gaze directions, so that various DTPTs 230 may be dimmed in advance and in anticipation as to where the viewer's gaze direction might be in the immediate future. This does not necessarily have to be limited to a single determined future gaze direction, i.e., a plurality of potential future gaze directions may be determined, and the DTPTs 230 associated with all potential future gaze directions may be dimmed. Once an actual gaze direction is determined, the DTPTs 230 associated with the unrealized potential future gaze directions may be undimmed.

In general, the response time of the darkening should be such that it can protect the viewer's 20 sight from bright flashes, such as lightning or a car with its brights on turning into the viewer's 20 gaze. The response time is based on: 1) the sensor/camera 240 speed for detecting light 10 positions and intensities, object positions 30, viewer 20 and eye 25 positions and orientations; 2) processing times to determine light and object ray intersections with particular DTPTs 230; and 3) response time of electronics associated with the control and the dimming/darkening of the DTPTs themselves. For example, if a total response time of 50 ms is desirable, then adequate processing power would have to be employed to ensure the overall response time can be met. This may involve the use of multiple processors and a high-speed bus/network.

The processing power required further takes into account the number, size, and shape of the DTPTs 230 in a DTP 220. For example, a larger number of smaller-size DTPTs 230 will require greater processing power. Furthermore, the shape of the DTPT 230, i.e., the outline/perimeter shape, that is more complex will require greater processing power, and if the DTPT 230 has a curved surface instead of being flat, this may require greater processing power as well. In some embodiments, however, such complex shapes may be represented by more simplified shapes in order to case computations.

Similarly, the outward-facing right and left cameras C_{OL}, C_{OR} 240.3, 240.4 may be used to determine positions of the light source(s) L1 10.1, L2 10.2, and object(s) O 30. In some instances, the light source L 10 and/or the object O 30 may be far enough away that its precise distance cannot accurately be determined. In this case an infinite distance may be used (e.g., represented by a very large number), and the light rays 12 may be considered as radiating from an infinite distance.

In any case, the intersection of the light ray 12 from the light source L 10 to the viewer's 20 eye 25 may be determined for each light source L 10 and each viewer P 20. Similarly, the intersection of the light ray 12 from the object O 30 to the viewer's 20 eye 25 may be determined for each object 30 and each viewer P 20 by the object detector 340. For the light source(s) L 10, the DTPT 230 at which the light ray 12 intersects the DTP 220, the DTPT 230 may be dimmed. The positions of light sources 10, objects 30, viewer 20 and viewer eyes 25 may be made relative to known/predefined camera 240 positions that are established at a time of, e.g., an installation of the system, although known calibration techniques may be utilized to ensure accuracy.

In some instances, the light source L 10 is not a point light source, but comprises some visual area in the scene. In this instance, a plurality or set of light rays 12 may be determined that represent the boundaries of the light source L 10. In these instances, a plurality of DTPTs 230 may be dimmed for a particular viewer 20, based on the plurality or set of light rays 12 corresponding to the boundaries of the light source L 10. In some embodiments, this may be done for both eyes 25 of the viewer. In a similar manner, the object O 30 may not be a point object, and hence, the same principles apply for not dimming line-of-sight rays from the object O 30.

In some situations, it may be difficult to discern a light source L 10 from an illuminated object O 30. In some embodiments, various algorithms may be used to delineate between the two. In a first embodiment, the processor may determine whether a group of pixels has a brightness or luminosity greater than X times those around it (or according to some predefined threshold), and possibly additionally, that is not directly in the critical field of view. In this situation, the element may be deemed a light source that should be attenuated. In some embodiments, an artificial intelligence classifier may be used to determine what the “objects” are in the field of view are, and then only respond to those that meet certain predefined criteria (e.g., those that are vehicles, (cars, trucks, motorcycles, etc.) and/or respond to those that have a brightness or luminosity greater than a particular predefined threshold. In some embodiments, the system does not need to perform continuous scans and may establish an adaptive brightness/luminosity threshold to which it can react if exceeded and the “object” is outside the critical field of view (i.e., the system may be able to block relatively small areas to not obstruct critical line of sight or objects.) In some embodiments, the artificial intelligence in conjunction with the brightness/luminosity level detection may define what an object is, and where, if, and when it is to be masked.

In some embodiments, a prioritizer 350 may be used to designate a priority viewer 20 or a hierarchy of priorities of viewers 20. By way of example, if a driver of a vehicle is considered a driver (primary) viewer 20.1, and a passenger of the vehicle is considered a passenger (secondary) viewer 20.2, then the prioritizer may direct the processor 310 to give priority to the driver viewer 20.1. In this instance, the processor 310 may, absent input from the prioritizer 350, determine that two separate DTPTs 230 should be darkened, the first to protect the eyes 25.1 of the driver viewer 20.1, and the second to protect the eyes 25.2 of the passenger viewer 20.2. However, with the prioritizer 350 active, it may be determined that darkening the DTPT 230 to protect the eyes 25.2 of the passenger viewer 20.2 may also obscure on object O 30 from the driver. Since, in this example, the driver viewer 20.1 is given priority, the DTPT 230 that would otherwise be darkened to protect the passenger viewer 20.2 is not darkened so that the driver viewer 20.1 can still see the object O 30. A similar approach may be used for a pilot and a co-pilot in an aircraft, depending on who is flying the aircraft.

In some embodiments, an “auto-kill” or “master off” switch or signal may be employed to disengage/disable the dimming system. This switch or signal may be utilized to immediately shut off the dimming system by a viewer 20, and may be implemented by a physical switch that the viewer 20 might engage, or a spoken command of the viewer 20 that is interpreted by the system. This switch may be useful in the event the dimming system becomes too distracting or in the event that an object requiring a high degree of viewer attention is present. Engagement of the switch or receipt of the signal may remove any dimming effect on all DTPTs 230 in the system 200. In some embodiments, this switch or signal may be activated externally. By way of example, if a police officer stops a vehicle, or EMTs are responding to an emergency, a signal may be sent by the officer's or EMT's vehicle or other communication unit to activate the master off process. Similarly, the viewer's own vehicle may be able to sense such vehicles and activate the master off in response.

In some embodiments, a viewer 20 may be wearing dimmable glasses. In such an instance, where the glasses are smart glasses, these may operate in conjunction with the system to ensure that the DTPTs 230 are dimmed to a proper level. If the viewer's glasses are capable of providing the processor with information about their level of dimming, the processor can take the glasses level of dimming into account when determining a level of dimming for the DTPTs 230. The same principle may be applied when the DTP 220 already has a fixed shade applied, as might be the case for building windows or vehicle windows having permanently-tinted windows. In these cases, a pre-existing amount of tinting may be taken into effect before making the dimming amount decision.

In some embodiments, the viewer's 20 wearable dimmable glasses may be controllable by the processor, as might be the case for smart glasses. This might be the case where the overall level of light is high, such as might be experienced by a driver of a vehicle on a sunny day. In this case, a darkening command may be sent to the lenses of the dimmable glasses to bring the overall level of light to a more comfortable level, and adjustments to the DTPTs 230 are only adjusted when necessary, taking into account a darkening level of the dimmable glasses. The processor, however, would not darken the dimmable smart glasses to the point that objects 30 might be missed by the viewer 20.

If the viewer's glasses are not capable of directly providing the processor with level of dimming information, it may be possible for the inward-facing cameras 240.1, 240.2 to estimate a level of dimming by scanning the lenses of the glasses. This may apply regardless of whether such glasses adjust a level of dimming or have a fixed level of dimming, as would be the case with ordinary sunglasses.

In some embodiments, the system has the capability to save information about and learn from viewer preferences. For example, the user may indicate a preference for dimming the DTPTs 230 associated with an object 30 at 50%, as opposed to not dimming at all (i.e., 0%) when the light 10 is at a certain level. The viewer may have the ability to provide such configuration information up front (i.e., before operating the system), but may also have the ability to change or adjust the system performance, such as a level of dimming, precision of the dimming (how tightly DTPTs should be dimmed around the light source), etc., in real-time as the system is in operation. Such configuration information may be learned by a machine learning system that may then rely upon stored historical information and adapt the system performance over time to a viewer's 20 preferences.

The viewer may interact with the system through voice, or a general graphical user interface to adjust an object brightness threshold that requires dimming. This may be done globally as a system, and configured by, e.g., an individual that is recognized (via voice, facial recognition, or other user-authenticating technology) in the driver's seat. The dimming level may automatically adjust as the outside environment changes from light to dark or dark to light as well.

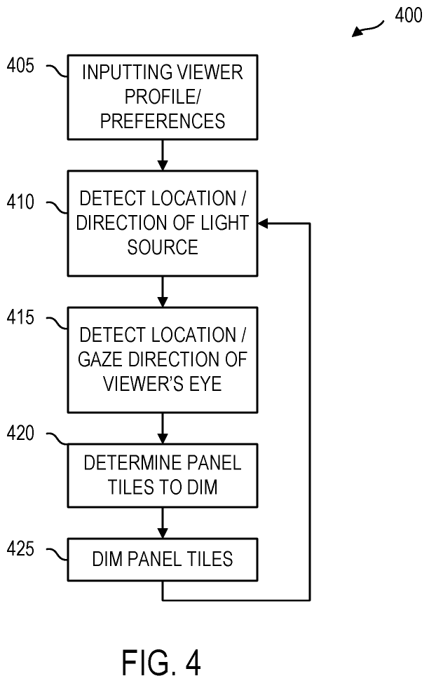

FIG. 4 is a flowchart of a basic process 400 that may be used for selectively dimming a subset of DTPTs 230. In an optional operation 405, a viewer 20 profile that may include various viewer 20 preferences may be loaded in from a storage memory that contains various operational values usable by the system 200. These values may include, but are not limited to, timing associated with dimming (e.g., responsiveness and the like), prioritization for different viewers, voice commands, etc. These values may be used by the processor 310 in determining which DTPTs 230 to dim, and the respective amount of dimming, including the timing, etc.

In operation 410, the light source detector 330 may obtain a location and/or a direction of a light source 10. This may be done using the outside facing cameras 240.3, 240.4 and the processor 310, its own local processor, or another processor. In operation 415, the head/eye detector 320 may obtain a viewer's eye 25 position and orientation in order to determine a gaze direction. This may be done using the inside facing cameras 240.1, 240.2, and the processor 310, its own local processor, or another processor.

In operation 420, the processor 310 may determine which DTPTs 230 are to be dimmed and by what amount. This may be achieved, in some embodiments, by the following operations. A line segment, ray, or vector of the light ray 12 between the light source 10 and the viewer's eye gaze 25 may be determined. The point at which this light ray 12 intersects the DTP 220, the light ray intersection position 14, forms the point about which adjacent or inclusive DTPTs 230 are to be dimmed and the amount that these DTPTs 230 are to be dimmed. In operation 425, signals may be sent to the DTPTs 230 in order to dim them by an amount previously determined in operation 420.

### Technical Application

The one or more embodiments disclosed herein accordingly provide an improvement to technology, namely to an improvement in protecting a viewer's eyes by selectively dimming portions of a transparent panel in response to a changing light source.

What is claimed is:

1. A method for selective dimming of a proper subset of a plurality of tiles (DTPTs) that are a part of a contiguous dimmable transparent panel (DTP), the method comprising:
using a processor and in a real-time continuous feedback loop:
detecting, using a light source detector with an outward facing sensor, a location of an illumination source within a volume adjacent to an outside surface of the DTP;
determining, using a head/eye detector with an inward facing sensor, a viewer's gaze direction within a volume adjacent to an inside surface of the DTP;
determining a panel intersection point for a light ray extending from the illumination source location along the viewer's gaze direction; and
selectively dimming the proper subset of DTPTs proximate the panel intersection point.

2. The method of claim 1, further comprising:
inputting a profile or preferences of the viewer; and
using the profile or preferences to determine the proper subset of DTPTs to dim or an amount to dim the proper subset of DTPTs.

3. The method of claim 1, wherein the DTPTs are selected from the group consisting of electrochromic devices and micro-shutter devices.

4. The method of claim 1, wherein:
the inward facing sensor comprises an inward facing camera apparatus comprising at least two cameras; and
the outward facing sensor comprises an outward facing camera apparatus comprising at least two cameras.

5. The method of claim 1, further comprising:
detecting an intensity of the illumination source with the light source detector; and
determining an amount of the selective dimming based on the detected intensity.

6. The method of claim 1, further comprising:
determining an actual gaze angle of the viewer relative to the light ray; and
wherein the proper subset of DTPTs is determined based on the determined angle of gaze.

7. The method of claim 1, further comprising:
detecting, using an object detector with the outward facing sensor, a location of an object within the volume adjacent to the outside surface of the DTP;
determining an object panel intersection point for an object ray extending from the object location along the viewer's gaze direction; and
selectively not dimming or dimming by a lesser amount a proper subset of DTPTs proximate the object panel intersection point that would otherwise be dimmed.

8. The method of claim 1, wherein the viewer is a primary viewer, the method further comprising:
detecting, with the inward facing sensor, a secondary viewer's gaze direction within the volume adjacent to the inside surface of the DTP;
determining a second panel intersection point for a second light ray extending from the illumination source along the secondary viewer's gaze direction; and
selectively dimming a second proper subset of DTPTs proximate the second panel intersection point.

9. The method of claim 8, further comprising a prioritizer configured to dim the second proper subset of DTPTs less than the proper subset of DTPTs or to not dim the second proper subset of DTPTs at all when the prioritizer is active.

10. The method of claim 1, wherein the DTPTs of the DTP are contained in a thin film, the method further comprising applying the thin film to a transparent panel surface.

11. The method of claim 1, wherein the sensors are selected from the group consisting of lasers, light detection and ranging (LIDAR) systems, sonic distance, and velocity measuring mechanisms.

12. The method of claim 1, wherein the viewer's eye is a right viewer's eye, the method further comprising:
detecting, using the head/eye detector, a viewer's left eye gaze direction;
determining a left eye panel intersection point for a light ray extending from the illumination source along the viewer's left eye gaze direction; and
selectively dimming the proper subset of DTPTs proximate the left eye panel intersection point.

13. The method of claim 1, further comprising:
determining an environmental context that includes at least an ambient level of lighting; and
using the determined environmental context in the amount of selective dimming to apply to the proper subset of DTPTs.

14. The method of claim 1, further comprising:
varying an amount of dimming based on a field of view angle from the viewer's gaze direction.

15. The method of claim 1, further comprising:
determining a plurality of light rays representing boundaries of the light source having a visual area;
determining a plurality of panel intersection points for each of the plurality of light rays; and
selectively dimming a further proper subset of DTPTs proximate the plurality of panel intersection points.

16. The method of claim 1, further comprising:
receiving a master off signal by the processor; and
responsive to receiving the master off signal, disengaging all dimming of the DTPTs.

17. The method of claim 1, further comprising:
determining a dimming level of dimmable glasses being worn by the viewer; and
using the determined dimming level in determining the subset of and level of dimming to apply to the subset of DTPTs.

18. The method of claim 1, further comprising:
storing viewer changes or adjustments in a historical database; and
using a machine learning system to adapt system performance over time to accommodate preferences of the viewer.

19. A system for selective dimming of a proper subset of a plurality of tiles (DTPTs) that are a part of a contiguous dimmable transparent panel (DTP), comprising:
a memory; and
a processor that is configured to, in a real-time continuous feedback loop:
detect, using a light source detector with an outward facing sensor, a location of an illumination source within a volume adjacent to an outside surface of the DTP;
determine, using a head/eye detector with an inward facing sensor, a viewer's gaze direction within a volume adjacent to an inside surface of the DTP;
determine a panel intersection point for a light ray extending from the illumination source location along the viewer's gaze direction; and
selectively dim the proper subset of DTPTs proximate the panel intersection.

20. A computer program product for a selective dimming apparatus for selective dimming of a proper subset of a plurality of tiles (DTPTs) that are a part of a contiguous dimmable transparent panel (DTP), the computer program product comprising:
one or more computer readable storage media, and program instructions collectively stored on the one or more computer readable storage media, the program instructions comprising program instructions to:
detect, using a light source detector with an outward facing sensor, a location of an illumination source within a volume adjacent to an outside surface of the DTP;
determine, using a head/eye detector with an inward facing sensor, a viewer's gaze direction within a volume adjacent to an inside surface of the DTP;
determine a panel intersection point for a light ray extending from the illumination source location along the viewer's gaze direction; and
selectively dim the proper subset of DTPTs proximate the panel intersection.
